(19) United States
(12) Patent Application Publication
(10) Pub. No.: US 2004/0178373 A1
(43) Pub. Date: Sep. 16, 2004

(54) Card counter and method of counting cards

(76) Inventors: Warren S. Graber, Hoffman Estates, IL (US); Ryan J. Kuester, Wauconda, IL (US)

Correspondence Address: JAMES W. POTTHAST, POTTHAST & ASSOCIATES, 2712 N. ASHLAND AVENUE, CHICAGO, IL, 60614-1106, US

(21) Appl. No.: 10/389,662

(22) Filed: Mar. 14, 2003

(51) Int. Cl. G01V 8/00; G01N 21/86

(52) U.S. Cl. 250/559.36

(57) ABSTRACT

An automatic card counter (20) with a housing (22) with an open front with a card deck assembly (24) having a front opening to a card counting location and an underlying support for a stack (29) of cards (30) such as may be contained in a card box, such as plastic opaque, transparent or translucent credit cards, with an optical sensing system for detecting the edges of the cards (30) in the stack (29) to determine the number, or count, of the total number of the cards (30) in the stack (29) includes a light source (64) composed of an elongate string of a plurality of high intensity light emitting diodes directing red light rearward and downwardly away from the front card deck opening and along the entire length of the stack of cards through a window (96), a mirror (76) for simultaneous reflecting a complete image of the entire stack of cards downwardly and rearward to another mirror (100) that reflects the complete image rearward and horizontally to a lens system (108) with a relatively wide depth of field to focus the image on a photosensor (10) composed of a linear array of approximately ten thousand charge coupled devices that produce electrical signals that are converted to numbers by an A/D converter and processed by a microprocessor (116) to distinguish real cards from persons fingers, the edges of card boxes (28) and other like object that may routinely appear in the field of view of the card stack. The card deck (26) is a planer member that is supported above a support surface (47) by legs (35) and is removable mounted to enable the counting of oversized cards or cards on end by removing the card deck (26) and supporting the card counter (20) on supporting them on the support surface (47).

### CROSS-REFERENCE TO RELATED APPLICATIONS

This application is a continuation-in-part of claims under 35USC120 the benefit of U.S. patent application Ser. No. ______, filed Mar. 11, 2003, by Certificate of Express Mail, Express Mail Receipt No.EU905429737US, of the same co-inventors as the present application and entitled, “Automatic Card Counter and Method of Automatically Counting Cards”, or, if such application is not given a filing date of Mar. 11, 2003, but is converted to a provisional patent application with a filing date of Mar. 11, 2003, then this application claims the benefit of that application under 35USC119(e).

### BACKGROUND OF THE INVENTION

1. Field of the Invention

This invention generally relates to automatic card counters used for counting credit cards on the like and more particularly to such card counters that automatically count cards by optically imaging edges of the cards and associated method of automatically counting cards.

2. Discussion of the Prior Art

Automated card counters of the type that automatically count a rack of cards by optically sensing the edges of the cards when held in contiguous, adjacent relationship by a box or other device. Examples of such card counters and related methods of counting are shown in U.S. Pat. No. 4,978,845 issued Dec. 18, 1990 to Hill for “Card Counter with Self-adjusting Card Loading Assembly and Method”; U.S. Pat. No. 4,995,060 issued Feb. 19, 1991, to Hill for “Card Counter with Card Counting Preset Data Entry System and Method”; and U.S. Pat. No. 5,046,076 issued Sep. 3, 1991, to Hill for Credit Card counter with Phase Error Detecting and Precount Comparing Verification”, all of which are hereby incorporated by reference.

In these known card counters, the optical system is caused to move across or scan the horizontal stack of cards. This disadvantageously takes time for the sensor to scan in one direction and then return. The necessary drive mechanism employs a motor driving a pulley linkage or other mechanical linkage movably mounting the senor for scanning movement, and these part are unfortunately subject to mechanical wear and like all moving parts require lubrication and other maintenance and eventually wear out and must be replaced.

Another relative disadvantage of known card counter shown in U.S. Pat. No. 4,978,845 was the need to mechanically position the cards via a movable platform to a position at which the top edges of the cards were all located precisely at a preselected focal length from the sensor assembly lens in order to obtain a precise image of the card edges required for accurate sensing of card edges. Again, this mechanical movement is achieved with moving parts that can wear-out and break and require routine maintenance. In addition, the need for this movement of the card rack reduces the speed at which the card counter can be loaded with a stack of cards and then unloaded after completion of the scan. Other card counters require the cards to be placed in special holders or to be flipped over, and this additional card handling can potentially result in spilled cards and lost cards. In some counters, special holders or handlers used to insure that the cards edges of the cards being counted are located at the correct focal distance interfere with counting cards that are contained within a box or are simply held between a persons finger and thumb when not in a box.

Some known counters have difficulty accurately counting boxed cards that are wrapped with transparent shrink wrap, in odd sized boxes or that are held by hand, are odd sized cards or stacked length wise without special operator adjustments, if at all.

Another problem is the difficulty of known sensor systems used in some known card counters to accurately sense and detect the edges of transparent or translucent cards.

The counters constructed in accordance with these patents will effectively count opaque laminated Polyvinylchloride. (PVC) cards. PVC has been used worldwide for the manufacture of credit cards for nearly fifty years. Although it is still the media of choice for most credit card applications, recently, in the last several years, due to ecological reasons, marketing campaigns, costs, etc., the credit card issuing industry has been using a wide variety of medias in addition to PVC. These include polycarbonate, injection molded, PET, plastic coated paper and clear plastics.

The known counters noted above will count some of these medias with limited success, but the card counter must be specifically calibrated to count each individual type of media. This results in the card counting unit being dedicated to counting only one type of card and this is often not an economical solution for a user that issues different types of cards. There is therefore a need to provide a counter that can effectively count different medias including transparent without the need for changing fixed calibrations

These units are generally capable of counting a box of five hundred cards having a thickness of approximately 0.030″ (0.76 mm) thick, but there remains a need There is also a need for counting type ID-1 plastic cards in accordance with ISO/IEC 7810:1955(E) standard also formally known as ANSIX4.13-1971. The unit(s) shall be capable of counting embossed or un-embossed cards in the same scan with no operator adjustments. Also, some card issuers receive their cards in boxes with no top but with a clear plastic “heat shrink wrap” around the box and cards to contain the cards in the box, and there is a need for card counters that are capable of accurately counting the cards through this shrink-wrap material.

There is also a need for counters that are capable of counting larger than standard sized cards and generally cards of different sizes. In known, counters there are an elevating platform for raising cards of different height to a counting position. However, this mechanical mechanism has the inherent problems noted above and in and in the case of a fixed sized opening for receipt of the cards within the card counting location or a card holder, a limitation is imposed on the size of the cards that may be counted such that oversized cards cannot be counted

### SUMMARY OF THE INVENTION

It is therefore the principal object of the present invention to provide an automated card counter and method of automatically counting the edges of a stack of cards that overcomes one more of the disadvantageous features or limitations of card counters noted above.

This objective is achieved in part by providing in an automated card counter having a housing with a front with a card deck and a display for displaying the results of

This objective is achieved in part by providing in an automated card counter having a housing with a front with a card deck and a display for displaying the results of at least one counting cycle, a controller protectively contained within the housing and at least one manual control switch for controlling at least one of the functions of the controller, a card counting location on the card deck at which the edges of cards to be counted are positioned to be counted, an optical card edge detector located within the housing for detecting contiguous edges of a stack of cards for counting with a source of light for illuminating the edges of a plurality of cards located at the card counting location, a photosensor mounted in a fixed position within the housing for generating electrical signals representative of light received by the photosensor, means spaced from the photosensor for directing light of the light source dispersed from the contiguous edges of the stack of cards towards the photosensor, means for interfacing electrical signals representative of the directed light received by the photo-responsive sensor to the controller, and means included within the controller for interpreting the interfaced electronic signals to determine a count for display.

Preferably, the light directing means includes a mirror that directs light dispersed from the card edges away from the photosensor toward another mirror that reflects the light toward the photosensor. The reflected light is passed to a lens assembly and the lens assembly forms a reduced image of the entire stack of cards that is passed the photosensor as a single image.

Thus, in keeping with another aspect of the invention the light directing means includes means for creating a light path that folds back on itself and has a total light path length that is greater than a depth dimension of the housing, and the total light path is entirely contained within the housing. Preferably, the light source is directed downwardly away from the card deck opening and is located entirely within the housing and above the level of a card counting deck opening to reduce direct bright light passing unimpeded from the front of the unit.

Advantageously, the light source is mounted in a fixed position that spans the entire length of the card counting deck and is composed of a plurality of high intensity light emitting diodes a ratio of approximately one diode for each approximately two to ten cards being counted. The diodes are organized in approximately eight groups of approximately nine diodes each and the power applied to each diode group may be independently controlled to selectively change the intensity of the light being emitted by the group in order to optimize a uniform level of lighting across the entire stack of cards.

In addition, means are provided for selectively changing the power applied to all the diodes uniformly to selectively change the total intensity of output light being generated by all the light emitting diodes in order to obtain a uniform amount of light being reflected from cards having different reflective characteristics. This change in total light intensity is performed in response to a manually actuateable card-type switch for selecting either an opaque card type or a transparent card type. Alternatively, the light intensity is adjusted automatically to for optimal perfomance with different kinds of cards. The power supply controllers for all of the cards respond to selection of an opaque card being selected to apply one level of power to the light emitting diodes and respond to selection of a transparent card type being to apply another level of power to the light emitting diodes that is greater than the one level of power to increase the intensity of the light being emitted by the light source. The intensity of output light is increased by approximately two hundred per cent from the intensity of output light generated when the one level of power is being applied when the other level of higher power is applied.

In keeping with another aspect of the invention the lens system has a focal depth of field at least as large as the difference between the top of the shortest cards and the top of the card deck opening to enable the system to focus on the tops of the cards even though at different heights. This advantageously eliminates the need for a moving card deck, special card holders or counting of the bottom edges otherwise needed to put the card stack in focus. The light directing means includes a lens system having a plurality of lens aligned to both reduce and focus, or merely focus, an image on the photosensor The entire light directing system including the two mirrors reduces an image approximately eighteen inches long at the top of the card stack to an image approximately only one-half inch long focused on the approximately one-half inch on the light receiving face of the photosensor. Preferably, the photosensor is CCD with a serial array of sensels arranged in a line that is aligned with a strip image of the edges of stack of cards that extends along a length of the stack of cards.

The objective of the invention is also achieved by providing an automated card counter with means for supporting a stack of cards on edge in a card counting location, a photosensor for simultaneously sensing an entire image of the entire stack of cards, and means for converting the entire image sensed by the photosensor to a series of numbers representative of the image.

The objective is also achieved in part by providing an automated card counter having means for supporting a stack of cards on edge in a card counting location, a photosensor for sensing an image of the entire stack of cards, a plurality of mirrors for directing light from the stack of cards to the photosensor, and means for converting the image sensed by the photosensor to a count of the total number of cards in the stack.

Further, the objective is partly achieved by providing an automated card counter including means for supporting an elongate stack of cards on edge in a card counting location, means for providing a uniform luminosity of light reflected from the stack of cards at all locations along the stack of cards including the ends of the cards, a photosensor for sensing an image of the entire stack of cards, and means for converting the image sensed by the photosensor to a count of the total number of cards in the stack.

Additionally achieving object of the present invention is the provision of an automated card counter with means for supporting an elongate stack of cards on edge in a card counting location, means for directing light onto a maximum light position extending at a lateral position along edges of the elongate stack of cards at an acute angle from one lateral position on one of first and second sides of the maximum light position, a photosensor for sensing a strip image of the stack of cards obtained from a position that is adjacent the maximum light position, and means for converting the image sensed by the photosensor to a count of the total number of cards in the stack.

The objective is further obtained by providing an automated card counter having a housing, a display for displaying the results of at least one counting cycle, a controller and at least one manual control switch for controlling at least one of the functions of the controller and a card counting location with an upper most level at which the edges of cards to be counted are positioned to be counted, with an optical card edge detector located within the housing for detecting contiguous edges of a stack of cards for counting having a photosensor mounted in a fixed position within the housing for generating electrical signals representative of light received by the photosensor, means for directing an image of the card deck and any objects on the card deck to the photosensor, means for interfacing electrical signals representative of the image received by photosensor to a computer, said computer interpreting the interfaced electronic signals to determine a count for display and including means for distinguishing at least one of the objects of (a) a persons finger or thumb, (b) an edge of a box within which cards being counted are located, (c) a rubber band wrapped around the cards, and (d) any other non-card object, from an actual card.

Yet, the objective is acquired by providing for use in an automated card counter having a housing, a display for displaying the results of at least one counting cycle, a controller and at least one manual control switch for controlling at least one of the functions of the controller and a card counting location with an upper most level at which the edges of cards to be counted are positioned to be counted, a method of optically detecting the card edges and counting the number of cards in a stack of cards on edge by performance of the steps of illuminating the edges of a plurality of cards located at the card counting location with an artificial light source, a photosensor mounted in a fixed position within the housing for generating electrical signals representative of light received by the photosensor, directing light of the light source dispersed from the contiguous edges of the stack of cards towards a photosensor, focusing the reflected light directed toward the photosensor toward to simultaneously create a complete view of the entire stack of cards on the photosensor interfacing electrical signals representative of the directed light received by the photosensor to a computer, and interpreting with the computer the interfaced electronic signals to determine a count for display.

Moreover, the objective is partially obtained by providing for use in an automated card counter, a method of counting cards of a stack of cards on edge by performance of the steps of supporting a stack of cards on edge in a card counting location, simultaneously sensing with a photosensor an entire image of the entire stack of cards, and converting the entire image sensed by the photosensor to a series of numbers representative of the image.

Additionally, the objective of the invention is partially acquired by providing for use in an automated card counter, a method of automatically counting the number of cards in a stack of cards having the steps of supporting a stack of cards on edge in a card counting location,, sensing with a photosensor an image of the entire stack of cards, directing with a plurality of mirrors light from the stack of cards to the photosensor, and converting the image sensed by the photosensor to a count of the total number of cards in the stack.

Yet, additionally, the objective is obtained by also providing for use in an automated card counter, a method automatically counting a cards in an elongate stack of cards by supporting an elongate stack of cards on edge in a card counting location, providing a uniform luminosity of light reflected from the stack of cards at all locations along the stack of cards including the ends of the cards, sensing with a photosensor an image of the entire stack of cards, and converting the image sensed by the photosensor to a count of the total number of cards in the stack.

Again, the objective is also obtained by providing for use in an automated card counter, a method of automatically counting the number of cards in a stack of card through performance of the steps of supporting an elongate stack of cards on edge in a card counting location, directing light onto a maximum light position extending at a lateral position along edges of the elongate stack of cards at an acute angle from one lateral position on one of first and second sides of the maximum light position, sensing with a photosensor a strip image of the stack of cards obtained from a position that is adjacent the maximum light position, and converting the image sensed by the photosensor to a count of the total number of cards in the stack.

Additionally, the objective is acquired in part by providing for use in an automated card counter having a housing, a display for displaying the results of at least one counting cycle, a controller and at least one manual control switch for controlling at least one of the functions of the controller and a card deck with card counting location with an upper most level at which the edges of cards to be counted are positioned to be counted, a method of detecting contiguous edges of a stack of cards for automatically counting the number of cards in the stack by the steps of generating electrical signals representative of light received by the photosensor a photosensor mounted in a fixed position within the housing, directing an image of the card deck and any objects on the card deck to the photosensor, interfacing electrical signals representative of the image received by photosensor to a computer, with said computer the interfaced electronic signals to determine a count for display and including means for distinguishing at least one of the objects of (a) a persons finger or thumb, (b) an edge of a box within which cards being counted are located, (c) a rubber band wrapped around the cards, and (d) any other non-card object, from an actual card.

Moreover, again, the objective is achieved by providing a method of automatically counting the number of cards in an elongate stack of cards on edge, by performance of the steps of lighting the edges of the cards in the stack with a string of high intensity light emitting diodes extending along the entire length, reflecting an entire strip image of the entire length of the stack of cards to a lens system, focusing with the lens the entire strip image of the entire length of the stack of cards onto a linear photosensor array of charge coupled devices, converting electrical signals produced by the linear photosensor array to numbers representing light amplitude sensed by each of the charge coupled devices of the linear array of charge coupled devices, analyzing the light amplitude representative numbers to determine the number of cards in the stack; and displaying the number of cards in the stack.

### BRIEF DESCRIPTION OF THE DRAWING

The foregoing advantageous features will be described in detail and others will be made apparent from a following detailed description of the preferred embodiment of the card counter and card counting method that is given with reference to the several figures of the drawing, in which:

FIG. 1 is a perspective view of a preferred embodiment of the automatic card counter of the present invention;

FIG. 2 is a side view of the automatic card counter of FIG. 1 but with the outer housing, or cover removed to enable a view of the internal components;

FIG. 3 is a front elevation view of the automatic card counter of FIG. 2;

FIG. 4 is a plan view of the automatic card counter of FIG. 3;

FIG. 5 is a functional block diagram of the card counter of FIGS. 1-3;

FIG. 6 is a schematic side view Y-Z profile illustration of the lens system generally in FIG. 2 to illustrate the assembly tolerances;

FIG. 7 is another Y-Z profile similar to that of FIG. 6 but with the lens system protectively enclosed and held within a lens housing with a helical outer thread for mounting the system to the lens system mounting collar shown in FIGS. 2 and 4;

FIG. 8 is a side view of the inlet, or first lens, of the system shown in FIGS. 6 and 7 with labels used to understand some of the specifications indicated in the specification chart shown if FIG. 9;

FIG. 9 is a chart of specifications for the lens of FIG. 8;

FIG. 10 is a side view of the second lens of the system adjacent the lens of FIG. 8 with labels keyed to some of the specifications of the specification chart of FIG. 11;

FIG. 11 is a chart of specifications for the lens of FIG. 10;

FIG. 12 is a side view of the inlet, or first lens, of the system shown in FIGS. 6 and 7 with labels used to understand some of the specifications indicated in the specification chart shown if FIG. 13;

FIG. 13 is a chart of specifications for the lens of FIG. 12;

FIG. 14 is a side view of the inlet, or first lens, of the system shown in FIGS. 6 and 7 with labels used to understand some of the specifications indicated in the specification chart shown if FIG. 15;

FIG. 15 is a chart of specifications for the lens of FIG. 14;

FIG. 16 is an illustrative waveform of light intensity in association with the edges of the cards of a card stack.

### DETAILED DESCRIPTION

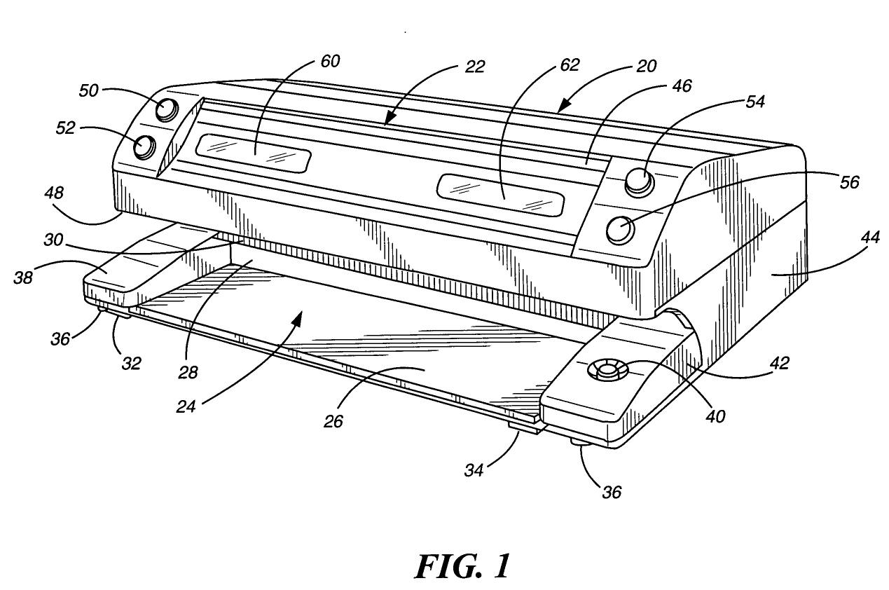

Referring to FIG. 1, the preferred embodiment of the card counter 20 an upper housing, or cover, 22 that is removably mounted to and protectively overlies a planer base assembly 24 and to protectively cover or frame the various elements of the counter as described below. The base assembly 24 includes a card deck 26 with an upwardly facing horizontal surface for supporting the bottom of a box 28 of cards 30, or for supporting the bottom edges of a group of cards being hand held in an upright position. The base assembly also includes an inwardly extending pair of support members 32 and 34 for providing underlying support to opposite sides of the card deck 26 onto which the card deck 26 is removably, slidably mounted. Four identical corner legs 36 high friction, rubber-like bottoms, or detachable feet hold the support members 32 and 34, the card base assembly 24 and the card deck 26 above the horizontal surface of a counter top or other underlying support surface upon which the automated card counter 20 may rest during use. Each of the corner legs are preferably threadably adjustable to enable adjustment of the height of the base assembly 24 and thus the upper housing 22 of the card counter 20 above the underlying support surface and to compensate for an uneven or non horizontal surface to provide secure support.

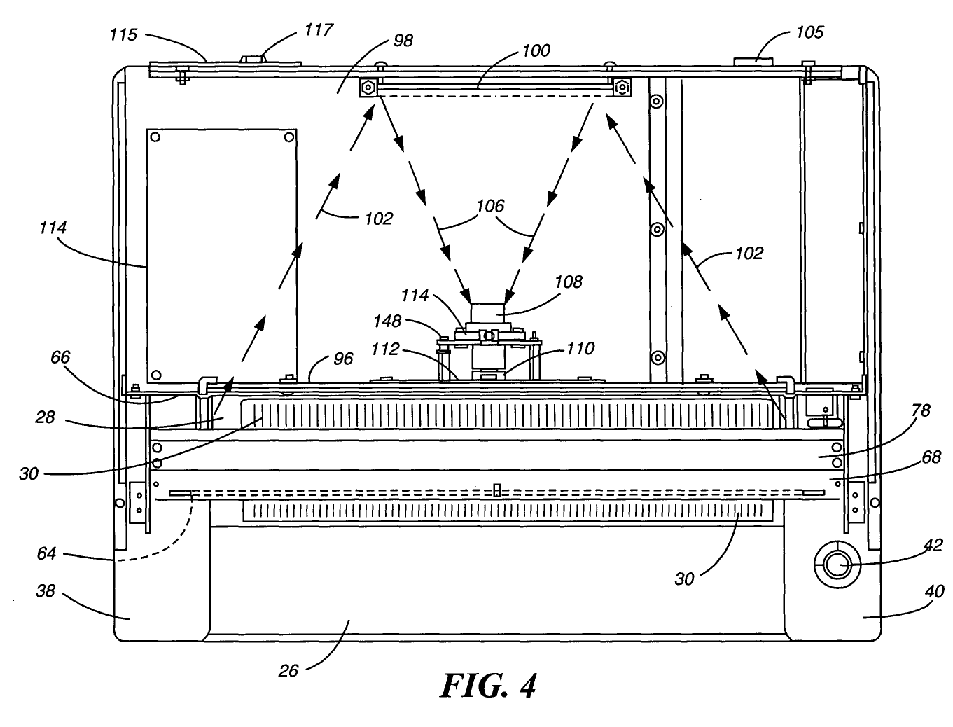

The base assembly 24 includes a pair of forwardly extending sections, or arms, 38 and 40 located on opposite sides of and extending upwardly from the level of the upwardly facing support surface of the card deck 26. The arms 38 and 40 have inner surfaces that extend. The arms 38 and 40 face one another throughout their length and continue forwardly from an intermediate wall 66 separating the counting location from the front section of the card counter 20. The arms extend from the card counting location at which the card box 28 is located with a back wall pressed against the intermediate wall 66. The distance between the arms, is approximately eighteen and one half inchs and defines the maximum width of the stack or box of cards that may be slid across the card deck 26 and into the card counting location adjacent to the wall 66. The arms 38 and 40 also function as a lateral and vertical guide for guiding the box 28 onto the card deck and into the counting position, as shown in FIG. 4.

The left arm 40 also covers electrical connections and mountings for a manual push button count switch 42 that is used to initiate a counting cycle of the card counter 20. The upper housing 22 is supported by sidewalls 44 above the arms 38 and 40. A forward portion of 46 of the upper housing 22 extends in cantilever fashion over the card counting location with its lowest surface 48. The lowest surface is at a height of approximately 4.25 inches inches above the upwardly facing surface of the card deck 26 that is normally sufficient to enable acceptance into the card counting location most sized cards or cards that are stacked on end instead of on their sides.

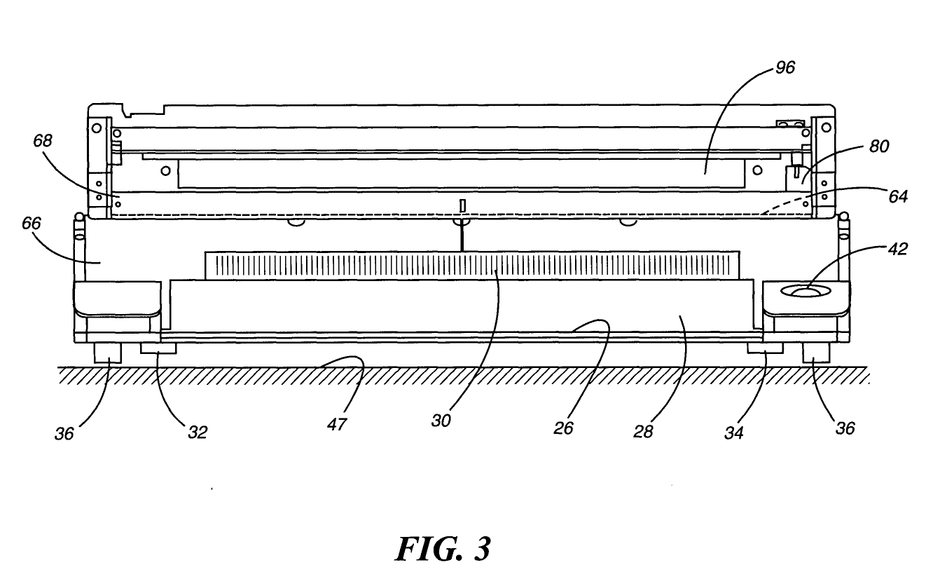

However, in keeping with one aspect of the invention, if it is desired to count cards that are too large to fit between the upper surface of the card deck 26 and the lowest surface 48 of the forward cantilevered section 46 of the upper housing 22, the card deck is slid out from underlying support by support members 32 and 34 and removed from the card counter. The oversized cards are then supported by the underlying support surface, such as support surface 47 shown in FIG. 3, instead of by the card deck 26. Andy fine adjustment of height may be made by adjusting the effective length of the legs. Alternatively, the support members support two card decks, one stacked upon another, and when greater clearance is needed to fit the box of cards beneath the surface 48 and into the card counting location, a top one of the card decks is removed. If even further card deck is removed and the cards supported by the support surface k4card deck is removed and the cards supported by the support surface 47.

The upper housing 22 has cutouts for receipt of a manual, preset push button switch 50 and a card type selection push button switch 52 on the right side of the upper housing 46 and a manual, totals selection pushbutton switch 54 and a manual, accumulator on/off pushbutton switch 56 on the left hand side of the card counter 20. The upper housing 46 also has a display plane 58 with display windows through which is seen a pair of digital, LCD display matrices, or displays 60 and 62. The display 60 is a count display window and is employed to display both the primary count and the secondary, or verification, count. The display 62 is the accumulator display window and is used to display the accumulated card count, which is the count accumulated in an accumulation section of a data memory from a plurality of individual counting cycles performed when the accumulator on/off switch 56 is in the on position. Alternatively, the accumulator display 62 selectively displays the number of accumulated count cycles, or boxes, counted. The displays 60 and 62 are also used to display user communication messages to the user and both of the displays 60 and 62 are preferably sixteen character displays to enable display of large accumulated numbers of cards and to enhance user communication during receipt of messages from the controller.

Two counts are performed during each counting cycle in response to actuation of the count switch 42. The first count is displayed on the right hand side of the count display 60 as the count and the second count is displayed on the left hand side of the display 500 as the verification count. A controller compares the two counts, and if the two counts are the same, then the count is verified as a good count. If not, then an error indication is provided and the two different counts are displayed. In accordance with the invention, both of the counts and the calculation and display of the counts is easily achieved in two seconds or less because there is no need for scanning because the image of the entire stack or box of cards 30 is sensed and counted at once as a single image.

When the preset switch is actuated, a verified count will be set into a precount memory and if the verified counts thereafter are not the same as the stored precount number another error message will be displayed indicating a precount error. If the precount is not actuated, then no comparison is performed.

The card types selection switch 52 is a rocker arm type switch that enables the user to select whether the cards 30 to be counted are transparent or translucent cards, or the one hand, or are opaque. Depending upon which card type is selected, different operating subroutines are selected for optimizing detecting the different types of cards. In the case of a transparent card, as opposed to a non-transparent card, the software functions to substantially increase the light intensity of the light source by a factor of approximately two in order to compensate for the amount of light that is absorbed instead of reflected in transparent cards as opposed to opaque cards. The exact amount of increase is the amount determined empirically to provide a substantially uniform level of light intensity being reflected from the cards.

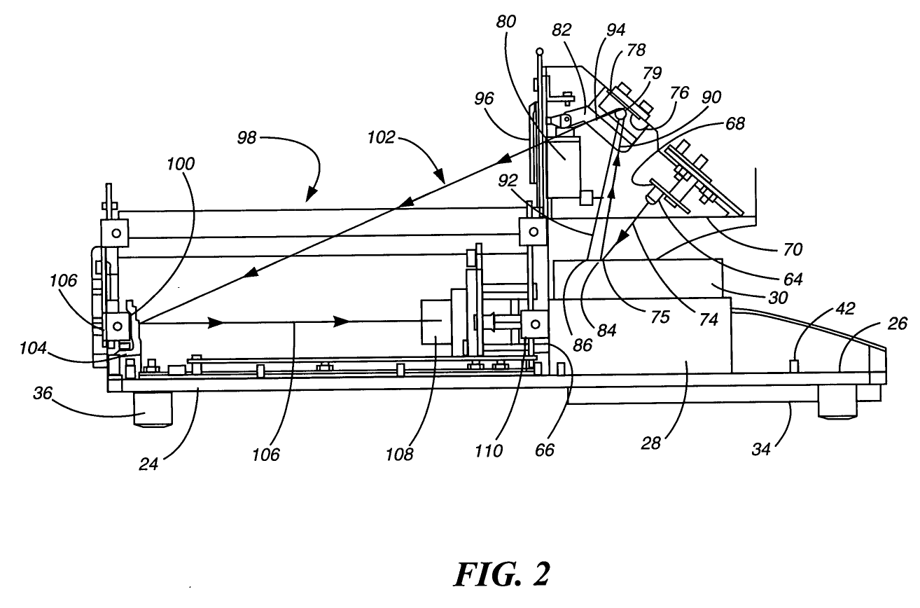

Referring now to FIGS. 2-4, in keeping with an important aspect of the invention, the mechanical scanning movement of either the sensing assembly or the cards themselves has been eliminated. Instead, both the optical sensing system and the cards themselves remain stationary during the counts. The optical system of the present invention has a number of components that are different from known scanning-type counters.

First, the light source 64, instead of being a fluorescent tube or strobe tube that are incapable of being turned to full intensity substantially instantly and have a relatively low useful life expectancy, in accordance with the present invention, the light source 60 is an elongate string or matrix of approximately seventy-two high intensity, light emitting diodes, or LEDs that bathes with high intensity LED light the entire approximately eighteen and one half inch width of the card deck and the top edges of any cards 30 of a stack of cards at the card counting position with high intensity LED light.

Preferably, the string of LEDs are formed of eight sets of nine LEDs and the power supplied to each set may be independently controlled to independently control the light intensity generated from each string. In accordance with the invention, LED power levels are controlled so that the light intensity generated by the groups of LEDs is greatest for those located opposite the central portion of the card deck 26 and is least for those located closer to the opposite ends of the card deck 26 and any cards on the card deck. This is done to optimize uniformity of light being dispersed from the card edges regardless of their location in the stack. It has been determined by the inventors that because of increased amounts of receipt of cross light from LEDs that are not directly above at the center compared to the opposite ends of the card stack the amount of reflected light intensity from the cards varies along the length of the stack if all of the LEDs are operating at the same level. The exact amount that the intensity should vary from the other groups is determined empirically, but generally the intensity at the end of the light string is on the order of twenty-five percent greater than at the center.

The LEDs are preferably high intensity light emitting diodes, emit red light and are arranged in linear groups of nine diodes each. The diodes are spaced appropriately to uniformly span the entire width of the card deck 26. Although many others may be used successfully, Model No.HLMP-ED25-TW000 Al—In—Ga—P LED Lamp made by Agilent Technologies Company have been found to be suitable light sources for the card counter 20 of the present invention. In the card counting location, the box 28 of cards 30 is resting on the card deck 26 and beneath the light source 64. Preferably the back wall of the box 28 or, if there is no box, the back edges of the cards 30, themselves, are pushed against the back wall 66 of the card deck 26. This light is preferably red from red LEDs for the advantages of reduced cost relative to other LEDs, such as blue LEDs. Also, advantageously, the photosensor 66 that detects the light from the stack of cards is an array of charge-coupled devices, or a CCD array, preferably the CCD Linear Sensor, Model No. ILX555K, made by Sony Corporation that has three channels for the three primary colors. The red channel provides the best response and this is another reason why red LEDs are preferred, but again other colors could be used successfully. Alternatively, the LEDs are white LEDs that emit white light and two or more of the channels of the CCD linear array are used to detect the card edges.

In keeping with another aspect of the invention, the light source 64 extends substantially the entire width of the card deck 26 and the card counting position to provide a uniform intensity of light across an entire box 28 of cards 30. While an elongate tube could be used with the other aspects of the invention, unlike an elongate tube, the LED's turn on relatively quickly so that there is less delay in starting a cycle. However, in keeping with another aspect of the invention, the level of electrical delivered to the individually ones of the string of LEDs is selectively controlled to obtain a more uniform level of illumination, even at the ends of the stack of cards 30, by increasing the light intensity output of the LEDs closer to the ends of the string, or series, overlying the opposite ends of the box 28 of cards 30. The inventors have noted that the level of intensity of light is reduced toward the ends of the box, or stack, 28 of cards due to the fact that light only arrives from one side as opposed to intermediate positions at which light arrives at the surface from LEDs on both sides of the intermediate position.

In addition, in the case of counting transparent or translucent cards, 30 the inventors have determined that detection and count accuracy are improved if the intensity of illumination of the tops of cards is increased to compensate for the reduction of reflective surfaces at the edge of the card as opposed to opaque cards that are more reflective. On the other hand, the light intensity for use with transparent cards is too high for optimal detection and accurate counting of opaque cards that reflect more of the light from the light source than do the transparent cards. Accordingly, in accordance with the invention when the card types switch 52 has been actuated to select transparent cards, the controller causes one level of power to be applied to the light source 64 to produce one level of light intensity striking the top edges 30 of the cards, but when the selection is opaque type cards then another level of power is applied to the light source 64 to produce another level of output light intensity that is less than the one level used when transparent cards are selected. Alternatively, the adjustment is performed automatically to obtain a preselected level of reflected light. The objective is to obtain the same level of reflected light intensity that is disbursed of the tops of the cards 30 by increasing the level of the light source to compensate for the increased amount of light absorbed and not reflected by the tops of the transparent cards as compared to opaque cards. In the present case, it has been found that the one level of light output for transparent cards should preferably be approximately fifty percent higher than the light output for opaque cards. While other light level sensing may also assist in optimal sensing of different colored opaque cards or cards of different height, and the invention contemplates making such light intensity adjustments if needed, they have not been found necessary in the entire system of the card counter 20 of the present invention. Generally, the best different levels of light intensity should be determined empirically as other system parameters may change.

As best seen in FIG. 2., the string of LEDs, or other light source, 64 is mounted on an elongate plate 68 with a reflective underside to reflect back to the top of the cards any light that returns in the direction of the light source 64 and the reflective plate 68. Another light absorbing, opaque, preferably black, plate 70 defines the top of the card deck 26 and card counting position and preferably absorbs some of the light that may be reflected upwardly and forwardly toward the opening of the card and the eyes of a user. Also, to prevent any direct light from impinging upon the eyes of a user, the light source 68 is located above the top 64 of the card deck. Moreover, reducing the likelihood of direct light leaking from the open front of the card deck and reducing the amount of high intensity reflected light leaking from the open front of the card deck assembly 24, the light path 74 of the light from the light source 68 is directed rearward away from the front of the counter 20 and toward the edges of the cards 30 being counted at a location 75.

In the case of the present embodiment in which the edges of the cards to be counted face upwardly, the light from the light source is directed both downwardly and rearward, but it should be appreciated that the invention could function the card edges facing downwardly and then all upward and downward directions of the light path would be reversed. However, the light would still be directed rearward away from the user. Preferably, the angle of incidence is an acute angle relative to horizontal of approximately fifty degrees, although other angles would be used if the light paths or relative locations of the optical elements were different.

Still referring to FIG. 2, the light is generally reflected and dispersed upwardly and rearward. Located above and rearward of the light source and on the same side of a normal plane extending vertically from the locations 84 and 86 at which the light is directed. This ensures that the light captured by the mirror90 will be light scattered off the top of the card stack rather than light directly reflected. It has been determined by the inventors that directly reflected light has too great a variation in intensity due to the discrete nature of the string of LEDs that make up the light source. The scattered light, on the other hand, provides a much more uniform intensity image. Importantly, the use of this scattered light also dramatically reduces the dependency of the image on the angle at which the cards sit, and the arrangement of the light source relative to the mirror that enable the counter 20 to count the cards even when they lean at significant angles such as ten degrees relative to vertical. The mirror is above the card deck and is an elongate, reflective member, preferably a planer mirror 76 preferably made from No. 303 stainless steel that has an outwardly facing surface polished to a mirror finish. The mirror 76 has a length approximately equal to the width of the card deck 26, in this embodiment approximately eighteen and one half inches. The mirror 76 is mounted to an elongate L-shaped mirror mounting bracket 78 including end walls with end pivot joints defining a pivot axis 79 to enable pivotal movement of the movably mounted mirror bracket 78 and resultant angular movement of the reflective plane of the mirror 76. A mirror solenoid 80 has a movable arm connected through an elbow shaped link 82 to the mirror bracket 78. When the solenoid is unenergized, the pivotally mounted mirror 76 is directed to face a first position 84 located rearward of the pivot axis 79 and adjacent to the location 75 at which the highest intensity of the light from the light source 68 is directed between the longitudinal center line down the length of the stack and the back edges of the cards 30 adjacent the back wall 66 of the card deck 26.

On the other hand, when the solenoid 80 is energized, then the mirror is pivoted to face another longitudinal count position 86 on the top of the cards 30 that is spaced slightly rearward from the first count position 84 but which is still relatively close to the highest intensity position 75. During each counting cycle both a primary count and verification or secondary count are performed. First, the solenoid is unenergized, and the mirror directs a direct image of the top of the card stack centered along the primary count position 84 is transmitted along a light path 90 to the mirror. The entire image of the entire stack along position 84 is reflected through a glass window 96 via a reflective light path 94. The entire eighteen and one-half inch image is passed a forwardly reflecting, second, rearward located, mirror 100 at the back of the card counter 20 along a light path 102. The second mirror 100 has a width of approximately eight inches is also preferably made of a highly polished flat plate of stainless steel. Because the second mirror 100 is separated from the first mirror by several inches it is able to have a field of view covers the entire view of the eighteen and one-half inch mirror 76 with a width of only approximately only eight inches long. The glass window 96 allows the light from the mirror 76 at the front section of the housing and exposed to the outside through the card deck access opening to pass to the mirror 100 within the entirely enclosed rear section 98 without exposing the lens system and mirror 100 to dust and other contaminates that might be introduced through the air from the front of the unit if the glass window 96 were not used while protectively isolating the rearward located optical elements card deck assembly that is open to airborne dust, etc. The angle of the light path 102 relative to horizontal is an acute angle of approximately twenty-two degrees, as shown.

The second mirror 100 is held in a relatively fixed angular position by a second, pivotally adjustable mirror mounting 104. The angle of the second mirror may be adjusted slightly by means of a manual adjustment screw 106 during initial alignment and calibration of the card counter 20 during the manufacturing process or later during set up or maintenance. However, the second, rearward reflecting mirror 100, once set to a correct angular position it remains fixed and is not moved to different angular positions during the two counts performed during each count cycle. When properly set, the reflected image of the entire box 28 of cards 30 is reflected forwardly to the light inlet opening of a lens system 108 along a generally horizontal light path 106.

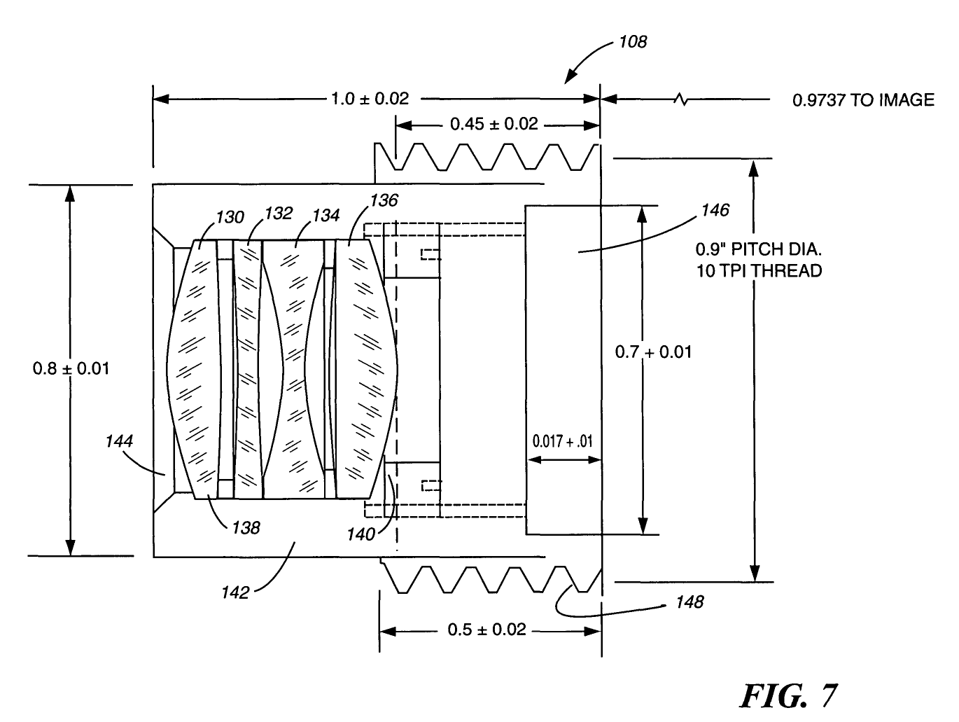

The entire image of the entire stack of cards 30 reflected from second mirror is received as a single image by the inlet lens 130, FIG. 7, of the lens system 108. This entire image as it passes from the mirror and through the lens system 108 further reduced in size and is focused by the lens system 108 onto a light receiving face of the photosensor 110. The photosensor 110 is located opposite the outlet end of the lens system 108, as best seen in FIG. 4. Preferably, the photosensor is a linear array of approximately ten thousand sensels of a CCD sensor, mounted on a circuit board 112 that also holds circuitry for converting the electrical signals generated by the CCDs into digital form for interfacing with the computer based controller 114, FIG. 4. While others could be used, a Ten-bit A/D Converter Model No. THS1041 made by Texas Instruments. During each count, output levels of all of the CCDs are sequentially converted a representative binary number that is temporarily stored and operated on by the detection software to detect the edges of the cards. In keeping with the invention, the integration time of the CCD is controlled to vary in a range between ten and thirty milliseconds by the controller automatically to optimized the imageIn keeping with an important aspect of the invention, the CCD array 110 preferably has approximately 10,000 pixels, sensels, or cells, such that there are a plurality of sensels responding to light from the edge of each card of standard width of approximately 0.030 inches, there being approximately fifteen or more pixels for each card edge. While a greater or lesser number of pixels per standard width card could be used, if too few are used then there may be difficulty in detecting cards that are much thinner than standard size cards while many more than fifteen are not needed to obtain good detection results. This high resolution substantially enhances accurate detection of the gaps between the cards and thus the number of cards, as well as helping in distinguishing box ends and users fingers from card edges. Preferably, the CCD matrix is a Three Color Channel CCD Linear Sensor, Model No. ILX555K made by Sony Corporation or the like.

The size of the light receiving face of the CCD linear matrix, or sensor is approximately one half inch in width. Thus, the image is reduced by the light directing system of the mirrors and lens system by a factor of approximately 18.5 to 0.5. The total length of all the light paths is approximately twenty inches and is substantially longer than the depth of the housing of the card counter 20. The lens system is mounted to a lens-mounting collar 114 that is supported at the ends of three screw adjustable standoffs (only two shown) 148 to enable slight adjustment of the tilt and spacing of the lens relative to the position of the CCD matrix 110. The lens system 108 is also threadably mounted to the collar 114.

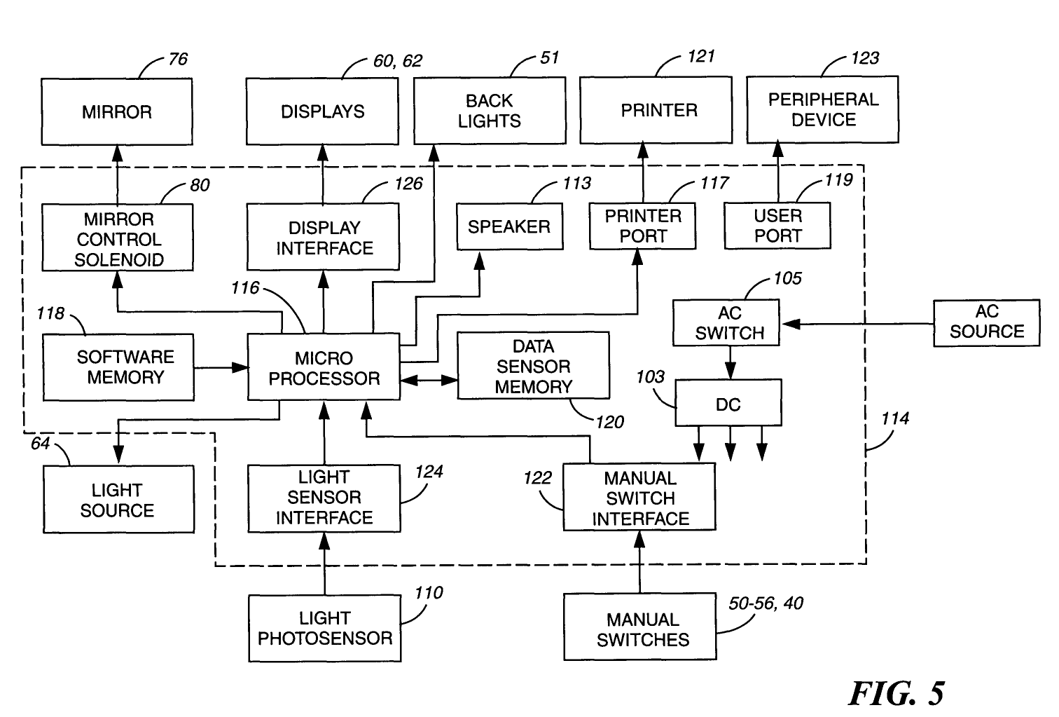

Referring to FIG. 5, the controller 114 of FIG. 4 is seen to include a microprocessor 116, preferably a Pentium™ II 486 Processor running at 266 Megahertz with a Linux operating system available from Red Hat and other distributors, or other like microprocessor with similar speed and memory characteristics. Any like computer with a printer output port and USB port could be used. A software memory 118 stores operating system software described below to control the response to various inputs and a data. A data and sensor memory 120 temporarily stores data from photosensor 110 during analysis and also stores the status of preselected control parameters and accumulated counting information for display and control. In accordance with the control program described below, the microprocessor responds to electrical signals received through one or more suitable manual switch interface circuits 122 that are generated in response to selective actuation of the manual switches 50, 52, 54, 56 and start count switch 42. During the count, the microprocessor 116 responds to digital electrical signals representative of the view of the top of the card stack generated by the analog-to-digital, or A/D, converter of a light sensor interface 124 which may be mounted on the same circuit card as is mounted the photosensor 110.

During the count cycle, after the primary count, the microprocessor 116 actuates the mirror control solenoid 80 to redirect the mirror to the location 86 from location 84 for the second, or verification, count. The difference in the angle of the mirror is approximately only five degrees and the separation of the two locations 84 and 86 is less than one-half inch. Different locations are used for the two counts because of the possibility of some surface anomaly at one location that may result in an incorrect count that is not present at the other location. It should be appreciated, however, if this extra precaution is deemed not needed, then the mirror solenoid 80 could be eliminated and both counts would be performed based on an image of the same location. Alternatively, a wider mirror could be employed to pass an image of both locations simultaneously to a pair of CCD linear sensors, respectively. The results of both counts as well as other information is passed to the displays 60 and 62 via a display interface circuit 126.

More specifically, the card counter 20 is caused to operate in response to the various operator inputs and automatic inputs as follows. The user interface is of course comprised of the two sixteen character displays 60 and 62 plus the five switches 50, 52, 54, 56 and 40 shown in FIG. 1.

When the A.C.power switch 105 is turned on, and power from and external power source connected to the switch 105 is applied to a D.C. power supply 103, the following sequence of events occur automatically in accordance with the operating program stored in software memory 118.

First, an internal self-diagnostic test of electronics communication and good operation of all of the LEDs of the light source 64 is performed. The display windows will display the message SELF TEST for approximately five seconds while the self-diagnostic subroutine runs.

The unit will then tested for the presence of a printer connected to a parallel printer port 115 or a USB port 117, FIG. 4. If a connection of a printer to the parallel printer port 115 is detected the microprocessor 116 causes display 62 to or printer to show a header message identifying the manufacturer or model name, for instance, that and two short beeps from the speaker 113 are sounded. Then the speaker 113 is energized to provide two slow audio beeps, and all of the CCDs of the photosensor 110, and all of the LEDs of the light source 64 are tested by turning them on temporarily, such as for two seconds. The communications capability of the printer interface associated with the printer port 115 and the communications interface associated with the USB, port 117.

After the AC power switch 105 is turned on and the usual 110/220, 60 Hz/50 Hz is provided to a D.C. power supply 103, power up testing is complete the following operations the card preset memory is set to the card preset number that had been stored at the time of the last power down when AC power was disconnected from the card counter power supply. If the preset function had been turned off with the preset button switch 50 at the time of the last power down, the preset is caused to remain off and the message PRESET OFF is displayed on display 60. This message continues to be displayed until the count button switch 42 is pressed and the backlight 51 for the preset switch button 50 is turned off. If the preset switch had been on previously then the preset value is displayed. If no value was stored but the preset was on at power down, then the preset memory is set to a factory set default number, preferably the number five hundred, which is the number of cards in a standard sized card box, and the message PRESET VALUE is shown in display window 60. This PRESET VALUE remains on display until the count button switch is pressed.

If the accumulator on-off switch 56 is off, then the message ACCUMULATOR OFF is displayed in the accumulator display window 62. This message continues to be displayed until the accumulator switch button is actuated to an on position, and then the message ACUMULATOR ON is displayed in the accumulator display 62. Then after approximately five seconds the digits 0,000,000 is displayed until the count switch button is pressed. The primary and secondary counts are performed sequentially and automatically during a count cycle performed in response to actuation of the count switch 42. If the primary and verification counts are the same, and match the stored precount number, if the precount function is on, a valid count is achieved within approximately two seconds after actuation of the count switch. Once a valid count is achieved, then this verified count is added to the total account stored in the accumulator memory and the new accumulator total is displayed on the accumulator display window 62 and all leading zeros are deleted.

The preset switch 50 allows a user to verify a known quantity of cards in a box, such as a standard sized card box of five hundred cards. The microprocessor compares the result of the count with the precount number stored in the precount memory. If the preset value does not match the card count, an alarm from the speaker 113 will sound, and the count will not be added to the stored or displayed accumulator total. If the backlight 51 for the preset switch 50 is illuminated, a single actuation, or single click, of the preset switch 50 causes the microprocessor 116 to display the current status preset in the left display window 60, such as PRESET=X,XXX for three seconds, where x,xxx etc. represents the current stored preset value The preset indicator light 51 will reflect a change. A double clicking of the preset switch 50 changes the present status, and both the left and the right displays 60 and 62 and preset indicator will reflect the change. If the preset backlight 51 is not illuminated, when the preset button 50 is single clicked the card counter 20 shall display PRESET OFF in the left window display 60 for three seconds. The power-on default for the stored preset number is five hundred and may be set between a minimum value of one and a maximum value of two thousand.

The preset number may be selectively changed. This change is accomplished by first placing a box of cards in the card counter counting location on the card deck assembly 24 with the desired number of cards to be the new preset. Then the count cycle start switch 42 is pressed while the preset switch button 50 is being held down. Both switches 42 and 50 are then released to start a count cycle. When the scan is completed, if both the primary and verification count are equal, e.g. both showing the number five hundred, the number counted and verified is entered into the precount memory. The user can obtain visual verification with display of the new preset number by clicking the preset switch button 50. In such case, the preset number will be then displayed for three seconds. The preset switch button and light will stay in the same state they were in prior to loading the new preset value. That is, if the preset switch button was on before the preset number was entered then it remains on.

The card type select switch is a rocker type switch. There are two positions: opaque card types and transparent cards type. When the count cycle start switch button is pressed, the microprocessor 116 will check the position of the switch. If the switch is in the down “OPAQUE” position the controller 114 is signaled for optimizing counting of opaque cards. The light intensity of the light source during the count cycle is adjusted to optimize accurate counting of the cards. It has been discovered by the present inventors that accurate counting of transparent cards shall be adjusted as well as any other adjustments necessary to identify and count opaque (white, colored and otherwise opaque) cards. If the card type switch is in the up, or “CLEAR” position, the microprocessor is signaled to make adjustments to optimize the counting of so-called clear cards that have edge and other components that are transparent or translucent and therefore absorb or translate light instead of reflecting all of the light impinging upon the card medium count clear and or translucent cards. The light intensity shall be adjusted as well as any other functions necessary to identify and count clear cards.

The number of cards counted by during the first or primary count taken along position 84, FIG. 2, is displayed on the left hand side of the count display 60 and the second or verification count taken along position 86, FIG. 2, is displayed on the right hand side of the count display.

The accumulator display 62 displays the accumulated total of all cards and the total of count cycles, or number of boxes counted, when all count cycles are counts of cards in boxes, which is the usual case. The card count and the box count are added to the accumulator totals only when the accumulator switch 56 is in the on position, both the count and verify counts for a box of cards match each other and, if the precount is on, also match the precount number.

The totals push button switch 54 is a non-illuminated, momentary action type push button switch. When the accumulator switch 56 is on, each time the switch button 54 is pressed, the accumulator display 62 will step between three different modes of operation. In the first mode, the accumulated card total will be displayed, and in the second mode of operation the accumulated box, or count cycle totals, are displayed. In the third mode of operation the user is given the option to clear all accumulated totals and the message “CLEAR ALL ACCUMULATED TOTALS” is displayed.

Assuming the accumulator switch 56 is in the on position, as indicated by the associated backlight being during the power up procedure, then word CARDS will be displayed on the left side of the accumulator display 46 and 0,000,000 is displayed on the right side of the accumulator display window 46. When the count switch button 42 pressed, the results of the first count shall be displayed in the accumulator display 46 and the leading zeros previously shown are deleted form the display. The word CARDS continues to be displayed on the left side of the display 62.

When the totals switch button 54 is pressed to display the accumulated box totals, the accumulator window 62 will display the total boxes, or counts performed successfully, on the right side of the display 62 and the word BOXES on the left side of the display.

In order to clear all totals, the user first presses the totals switch 54 until the message CLEAR ALL TOTALS is displayed. Pressing the count button 42 and performance of a successful scan while this message is displayed will clear from the accumulator memories the prior totals, and the new total from the new count that cleared the totals is stored and displayed on the accumulator display 62 as well as on the count display 60. If a printer or other peripheral display device is attached, the controller 114 will also cause the printer to print or the other peripheral device to display the message “TOTALS CLEARED” along with the date and time when the counter 20 performs the next successful count. If the accumulator display shows CLEAR ALL TOTALS and the totals are not to be cleared, then the user must press the total switch 54 at least once to recover the totals before the pressing the scan switch.

The last box of cards may be deleted from the accumulated totals by pressing and holding the totals switch 54 until an alarm sounds for approximately two seconds. The accumulator display 62 will reflect the changes. Once a count is deleted from the accumulator, it cannot be added back in without performing the count again. Only one count per scan can be deleted.

The accumulators on/off switch 56 turns the accumulator function on and off. When the switch 56 is in the on position, the card counter 20 is enabled to accumulate card and box counts and the totals switch 54 to select the totals displays is also enable. When the switch 56 is in the off position, the accumulator display window 62 will display the message ACCUMULATOR OFF. The user may still count the cards 30, but the card and box totals will not be added to the accumulator total. Any totals in the accumulator when the switch is turned off are held in the units memory and are not lost. When the accumulator on/off switch 56 is turned back on, the previous totals that were stored prior to the accumulator function being turned off remain stored and reappear in the accumulator display window 62 when selected for display through selective actuation of the totals switch 54.

Each time the count button is pressed the microprocessor performs all necessary diagnostics including light intensity adjustments, checking switch/button settings and the like. Then, presuming that the counter passes all operational test, optically scan the box or handful of cards. Two independent scans shall be performed. The first count will be displayed on left hand side of the count display 60 beneath the word COUNT printed on the housing above the display. The second count is displayed beneath the word VERIFY on the right hand side of the display 60. If the accumulator button is in the on position the and the count is verified and matches the precount, the number counted shall be added to the card total amount shown in the accumulator window. Also, the count cycle, or box, total memory, is incremented by one and is available for display if selected for display instead of the card count. If there is a printer or other peripheral device attached to the counter 20 the Count along with all pertinent information such as date, time, scan count, totals, etc., shall be outputted to the printer or other peripheral for printing, off-counter storage or off-counter display.

During setup programming in the program mode of operation instead of the operations mode of operation, the count display 60 is used to display the particular function being programmed or edited and the accumulator display 62 is used to shown the available selections or options for the function being displayed in the count display 60. Entry into the setup mode is achieved by the user depressing and holding depressed the totals switch button 54 while turning on the AC power switch 105 at the back of the counter housing 22. When the AC power switch 105 is turned on D.C. voltage at three different levels are generated by the D.C power supply 103. A twenty-four volt supply is provided for energizing the LEDs; five volts is provided for all of the logic circuits such as the A/S converter and microprocessor 116 while a negative twelve-volt supply is provided for the LCD displays. When these supply voltages come up to value, the microprocessor 116 causes the speaker 113 to sound a continuous audible tone until the totals button 54 is released. Once the card counter is in the setup mode, the message “SETUP MODE” is displayed in the count display window 60. If the counter 20 is not equipped with a printer, etc., if the user depresses and holds the totals button 54 while turning on the power, the counter 20 will simply power up and bypass this procedure.

The preset button 50 is used to move, or scan, through the list of displayed functions, with one step being taken down the list of functions for each actuation of the preset button 50. The totals button 54 is used to select the function edit. Once a function is selected the options for that function will be shown in the accumulator display 62. The preset switch 50 is used to move between the options, and the totals switch 54 is used to change the selected option. Pressing the count switch 42 will save the change and move the user back to the function select list in the count display 60. The program mode is exited by pressing the preset switch 50 until the word EXIT is displayed in the count display 60 and then pressing the count button again.

In addition to other functions, such as language, IP address, thick or thin cards and exit and the like, the date and time is one of the functions that may be set. The other functions are selected in a similar manner. In the case of setting of the time, the first action is to press and hold the totals switch 54 while simultaneously turning on the card counter 20 by switching on the AC power switch. An alarm will sound until the totals switch 54 is released. After releasing the totals switch 54 the count display 60 will show the first function on the list of programmable functions available. Pressing the preset button 50 will step through the function list until the appropriate time or date function is displayed, if it is not the first function displayed. Further pressing of the totals switch 54 will select the time to be edited. The current values of time are displayed in the accumulator display 62. The count window will display DATE and MONTH and pressing the totals button increment the number displayed in the Accumulator display.

Pressing the preset switch 50 will step between the hours, minutes, seconds and AM/PM options in the accumulator display 62. Pressing the totals switch 54 increments the value of the current item selected, such as hours. Finally, pressing the count switch 42 locks the new values into memory and the program returns to show the function list in the count display 60.

Specifically, pressing the preset switch 50 changes the display to shown the message DAY and pressing the totals switch 54 then increments the number displayed in the accumulator display. Pressing the preset switch button again will change the count display 60 to show the message YEAR and the totals switch 54 increments the number shown in the accumulator display 62. Pressing the preset button 50 again changes the left side of the count display 60 to show the message TIME and the right side to shown the message 00:00:00. Pressing the totals switch button 54 is pressed to increment the hours and then the preset switch button 50 is used to change to minutes for incrementing using the totals switch button 54. Pressing preset button 50 again changes to a mode to change the seconds by pressing the totals switch button 54 again to increment this value of the seconds. Finally, pressing the precount switch button 50 again changes the display to selection between AM & PM by use of the totals switch button. Finally turning off the count 42 will lock the new values into memory and return the microprocessor 116 to normal operation.

Changing the IP address, the language used for messages (English or Spanish) and the preset number and other selectable or programmable functions is performed in a Manner similar to the way in which the date and time are changed.

In accordance with the features of the present invention the card counter 20 is capable of counting a box of five hundred cards approximately 0.030″ (0.76 mm) thick cards within two seconds. The card counter meets all safety and RF standards for UL, CUL, CE as well as other world safety standards. The counter is capable of accepting line inputs of 100-240 VAC 50-60 Hz, and has a DC power supply 103 providing three different DC power levels as noted above and individually control power to the eight sections of the LED light source 64. The counting of type ID-1 plastic cards is performed in accordance with ISO/IEC 7810:1955(E) standard also formally known as ANSIX4.13-1971. The counter is capable of counting cards of thickness ranging from 0.010-040″ (0.25-1.02 mm) and is also capable counting embossed or un-embossed cards in the same count with no operator adjustments. In some cases, “heat shrink wrap” around the box and cards to is used to contain the cards in the box. The counter 20 is also capable, without operator adjustment, accurately count cards 30 while contained within a box 28 encased in transparent shrink-wrap by viewing the card edges through the transparent shrink-wrap material. The microprocessor 116 of counter 20 of course has the capability of attaching to a standard printer, such as printer 121, through a parallel printer port 117, to create hard copy printouts of reports, etc. may also communicate with other peripheral devices, such as peripheral device 123, via a USB port 119 and associated interface and may through these external connections network with other units or be accessed on line through a telephonic or other type communications modem.

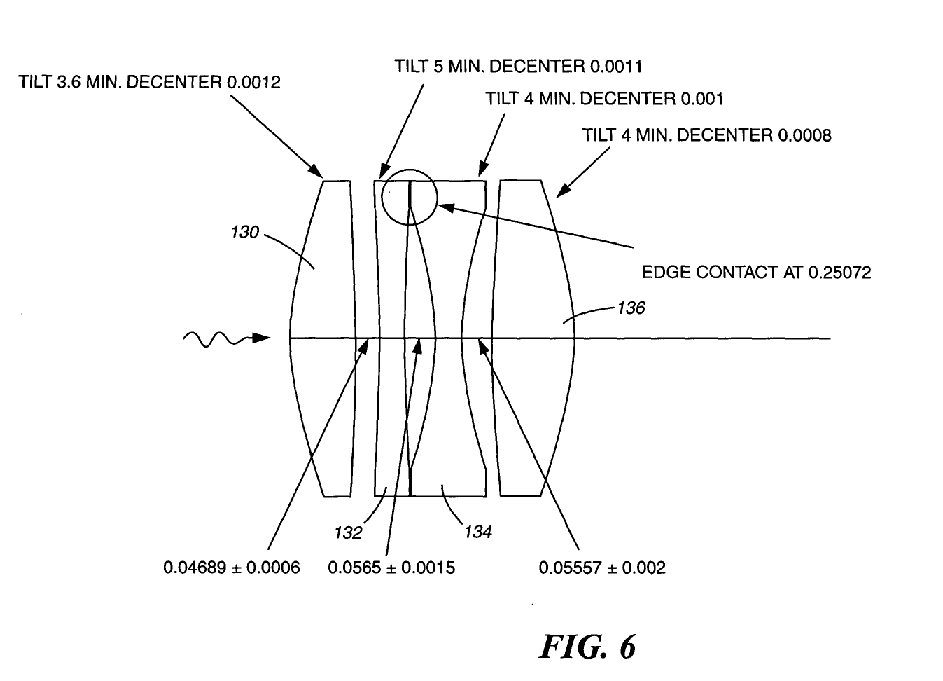

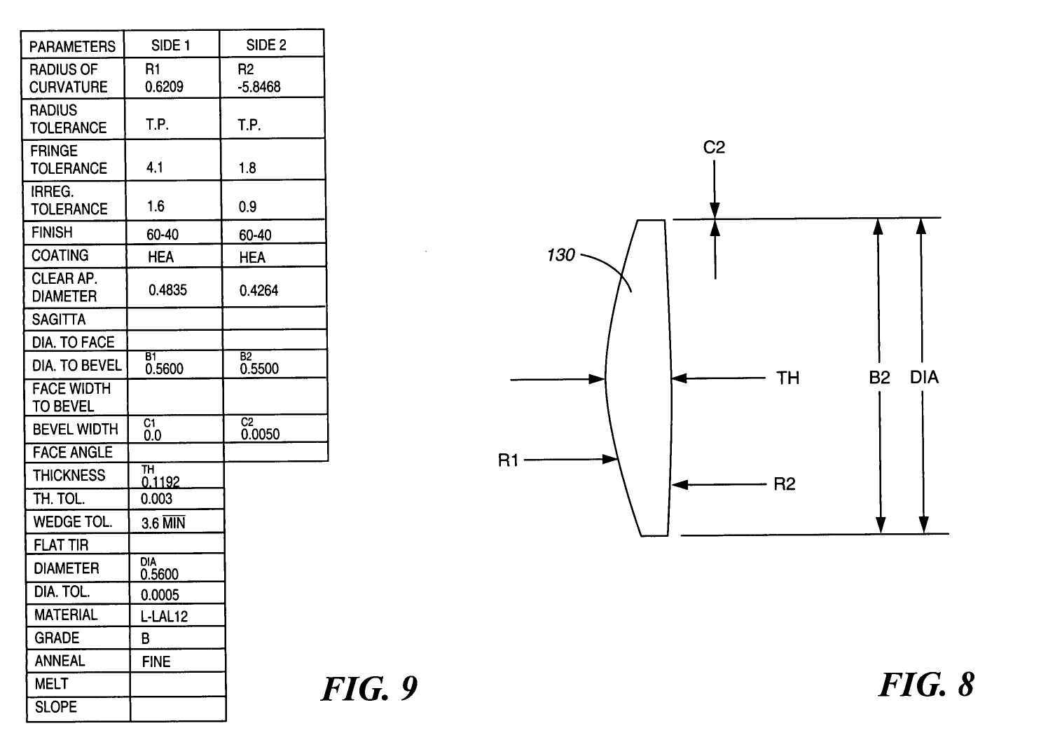

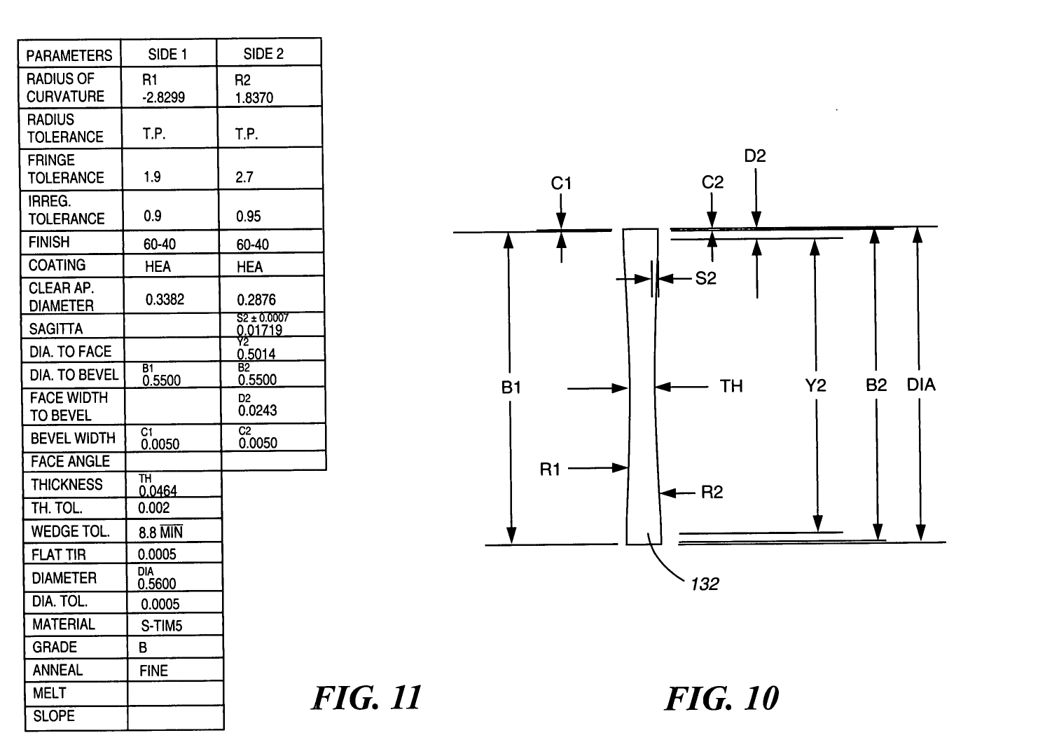

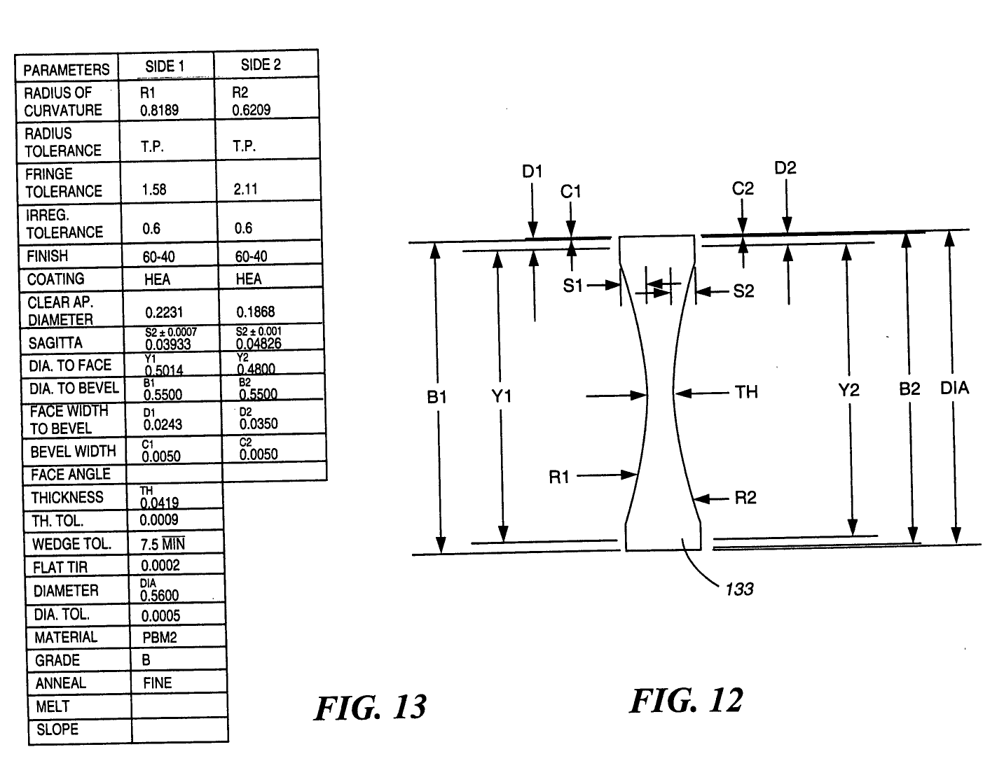

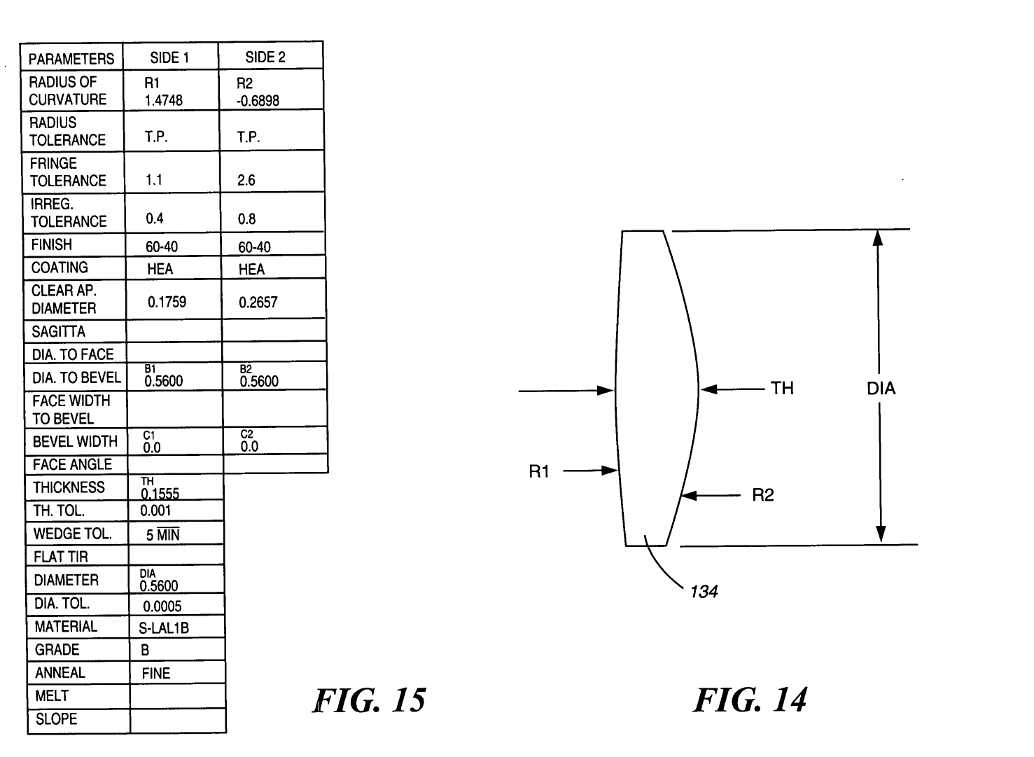

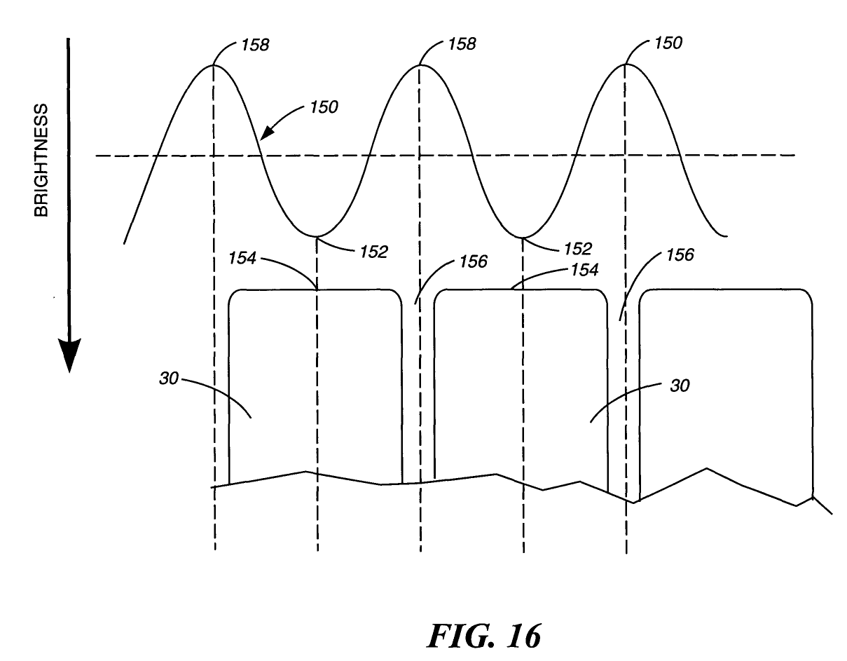

Referring to FIGS. 6 through 15, the preferred embodiment of the lens system is shown and specified. Referring to FIG. 6, the lens system has four circular lenses: a first lens 130 for receipt of the full image of the card stack, a second, intermediate lens 132, a third intermediate lens 134 and a fourth and final lens 136 from which the image of the entire card deck is passed to and focused on the light receiving, rearward directed, light receiving face of the photosensor 110. As seen in FIG. 7, the lenses 130-136 are mounted and held in proper axial alignment between a pair of spaced annular shoulders 138 and 140 within a steel, generally tubular housing 142. The tubular housing 142 has a light receiving opening 144 adjacent the first lens 130 and an outlet opening 146 spaced form the outlet lens 136. The outside surface located between the opening 146 and the lens 136 has an external thread 148 used to releasably and adjustably attachment to the mounting collar 114. The distance fro and the lens is recessed from the outlet opening 146 by approximately 0.45 inches. screwed to the collar 114 m the closest surface of the lens 36 and the face of the photosensor 110 upon which the image is focused is adjusted to be approximately 1.423 inches. Referring to FIG. 4 briefly, after the lens housing 142 is attached to the collar 114, other fine adjustment of dept and tilt may be made to the collar 114 and the lens system 108 carried thereby with three, threaded adjustment members 148 that are equally spaced around the mounting collar 114. The adjustments are made during manufacture to focus the image of the entire stack of cards on the light responsive face of the photosensor 108. Referring to each of FIGS. 8-14 the preferred specifications for each of the four lens is illustrated.

Referring to FIG. 17, the light reflected off of the stack of cards and as sensed by the photosensor 110 fluctuates across the length of the card stack in a roughly sinusoidal manner as shown by illustrative waveform 150. The most intense or brightest reflected lights, or peaks of brightness, 152 are received from the centers 154 of the edges of the cards 30 while the least intense, reflected light, or minimum levels 158 is reflected from the gaps 156 due to the loss of light passing between the cards and down the sides of the card.

The linear photosensor 110 images a strip of twenty inches along the top of the stack of cards at the counting location on the card deck 26. This strip is focused on a one-dimensional linear array of 10,680 CCDs of the photosensor 110. Each CCD may be considered a pixel and the relative brightness of each pixel is converted to a 10-bit binary number. These numbers are passed to the microprocessor 116 with the lowest numbers representing peaks of brightness 152 at the centers 154 of the card edges and the highest numbers representing the minimum values 150 occurring at the gaps 156 between cards 30.

In accordance with the present invention, a software program is provided in the software memory of the microprocessor 116 to operate on the numerical output representing the different levels of light intensity of the approximately ten thousand pixels to detect each card. This is done generally by detecting the peaks and valleys of the reflected light intensity. In addition, the software distinguishes between card edges and other objects that are in the field of view of the card deck but which are not cards, such a the edges of the boxes in which the stack of cards are contained, rubber bands, the fingers of a user holding the stack of cards when there is no box, pens and any other like item.

The following steps are taken to process the strip image of the card deck and the stack of cards.

First the raw number data is operated on using a DSP FIR filtering algorithm that functions as a low pass filter to ease detection of local minimum light levels on the scale of the expected card spacing. Different filters are preferably used for cards of significantly different widths to provide the proper scale of expected card spacing. Different card spacing selections may be made appropriate user programming in a manner generally described above with reference to inputting the time and date through use of the various switches and displays.

Next, the local minimum levels are identified and these minimums are used to define hypothetical cards.

Then, various features are extracted from each hypothetical card that are later used to distinguish real cards from “false” cards, or other items in the view that are not cards as noted above. The features that are extracted include (a) pixel location of the center 154 of the card, (b) amplitude of the card center in both the raw and filtered data, (c) location of the adjacent left and right maximum, (d) amplitude of the adjacent left and right maximum in both the raw and filtered data, (e) cross-correlations between the raw data of a card (a width of pixels centered about a minimum) and each of the two model curves and the filtered card data.

Next, “single-card rules” are applied to identify images of potential cards with features inconsistent with real card images to discard “false cards” from the count. These single-card rules include the following: (f) The right and left amplitude difference, or “height”, between the card center minimum and adjacent voltage or amplitude maximums in both the filtered and the raw data must be greater than a given difference threshold, such as ten millivolts; (g) the average height of the filtered data and the average height of the raw data must not differ by more than a certain threshold, such as ten millivolts, to eliminated spurious card detections caused by “filter ringing”; (h) if the strongest cross-correlation between the hypothetical card and the model card does not meet a minimum correlation threshold, preferably such as 0.5 (on a scale in which the maximum correlation is equal to one), and the raw data of the hypothetical card must be stronger than the filtered data.

After this, the card deck wide rules relating to the relationships between the neighboring card are applied, as follows: (i) cards must not stand alone as indicated by there being a maximum distance, preferably 0.040 inches, from neighboring cards; (j) no preselected group, or cluster of cards, may have a range of variable spacing between cards that exceeds a preselected maximum; and (k) cards must not have centers which are darker than the gaps between neighboring cards.

After all of the above rules are applied, it is assumed that all false cards have been eliminated from cards to be counted, but to make sure that no real cards have been also eliminated inadvertently and to add these cards back into the detected stack for counting, rules are applied as follows: (1) if the space between a card and the next adjacent card is large enough, such as a minimum of 0.050 inches, to potentially contain a card, a darker than normal threshold that is dynamically derived from the current card is used to “look” for a card possibly hidden in that space, and then (m) repeat this step with any newly found cards, and add all newly found cards to the cards to be counted. The step of looking for a card include using a darker than normal threshold, dynamically derived by computing one-fourth of the value of the current card.

Other rules may be applied if a white light source instead of a red light source is used, by using color to distinguish between cards and box edges, filler paper and operator fingers in addition to the above rules used with a monocolored light source.

While a particular embodiment has been disclosed it should be appreciated that many changes may be made without departing from the spirit and scope of the invention as defined in the appended claims. For instance, different light paths, different kinds and shapes and numbers of mirrors, different types of photosensors, computers, etc. than those identified here could be used with good result. What is most important is that there is not scanning and that an image of the entire stack of cards is imposed on the photosensor all at once to enable the count of the entire stack without movement of either the sensor system or the cards relative to the frame. It is also important that a dept of field of the light directing means be sufficiently deep that a good focus of the tops of the cards may be obtained despite normal variations in card size and the distance of the tops of the cards from the reflective mirror. The light path length contributes to this depth of field but a smaller length could be employed with a different depth of field of the lens system if such a wide variation in card size is not needed.

1. In an automated card counter having a housing with a front with a card deck and a display for displaying the results of at least one counting cycle, a controller protectively contained within the housing and at least one manual control switch for controlling at least one of the functions of the controller, a card counting location on the card deck at which the edges of cards to be counted are positioned to be counted, the improvement being an optical card edge detector located within the housing for detecting contiguous edges of a stack of cards for counting, comprising:
a source of light for illuminating the edges of a plurality of cards located at the card counting location;
a photosensor mounted in a fixed position within the housing for generating electrical signals representative of light received by the photosensor;
means spaced from the photosensor for directing light of the light source dispersed from the contiguous edges of the stack of cards towards the photosensor;
means for interfacing electrical signals representative of the directed light received by the photo-responsive sensor to the controller; and
means included within the controller for interpreting the interfaced electronic signals to determine a count for display.

2. The automated card counter of claim 1 in which the light directing means includes a mirror.

3. The automated card counter of claim 1 in which the light directing means includes a pair of mirrors that that reflect light dispersed from the top edges of the cards in generally opposite directions.

4. The automated card counter of claim 1 in which
the light directing means includes means for creating a light path that folds back on itself and has a total light path length that is greater than the depth dimension of the housing, and
the total light path is entirely contained within the housing.

5. The automated card counter of claim 1 in which light from the light source is directed downwardly away from the card deck opening and is located entirely within the housing and above the level of a card counting deck opening.

6. The automated card counter of claim 1 in which the light source is mounted in a fixed position that spans the entire length of the card counting deck.

7. The automated card counter of claim 1 in which the light source comprises a string of high intensity light emitting diodes formed of a number of diodes having a ratio of approximately one diode for each approximately two to ten cards being counted.

8. The automated card counter of claim 1 in which the light directing means includes a lens system for directing the light to the photosensor representing the entire length of the stack of cards.

9. The automated card counter of claim 1 in which the photosensor includes a charge coupled device.

10. The automated card counter of claim 1 in which
the light source includes a plurality of light emitting diodes, and including
means for selectively changing the power applied to the diodes to selectively change the intensity of output light being generated by the light emitting diodes.

11. The automated card counter of claim 1 in which
the light source is a light source that does not require a warm up time period to reach full luminosity but immediately switches to a level of intensity upon receipt of power associated with the level of power being applied, and including
means for applying power to the light source at the initiation of a count cycle and means for terminating power automatically at the end of a count cycle

12. The automated card counter of claim 1 in which the light directing means includes means for selectively directing the light from at least two different longitudinally spaced locations of the stack of cards.

13. The automated card counter of claim 1 in which the interpreting means includes a means for distinguishing between signals generated in response to the edge of a box within which the cards are located from the edge of a card.

14. The automated card counter of claim 1 in which the interpreting means includes means for distinguishing between signals representative of a view of the edges of a persons fingers holding a stack of cards on the card counting deck from the edges of cards on the card deck being held.

15. The automated card counter of claim 1 in which the light source in which the light source is an elongate series of light emitting diodes and in which the controller includes means for independently controlling power for at least some of the light emitting diodes to selectively control the level of light intensity at different segments of the card stack.

16. The automated card counter of claim 1 in which the light directing means includes a lens system having four lenses aligned to reduce an image approximately eighteen inches long at the top of the card stack to an image approximately only one-half inch long on the photosensor.

17. An automated card counter, comprising:
means for supporting a stack of cards on edge in a card counting location;
a photosensor for simultaneously sensing an entire image of the entire stack of cards; and
means for converting the entire image sensed by the photosensor to a series of numbers representative of the image.

18. The automated card counter of claim 17 in which the photosensor includes an array of charge coupled devices.

19. The automated card counter of claim 17 including a plurality of mirrors for directing reflected light from the cards stack to the photosensor.

20. For use in an automated card counter having a housing, a display for displaying the sresults of at least one counting cycle, a controller and at least one manual control switch for controlling at least one of the functions of the controller and a card counting location with an upper most level at which the edges of cards to be counted are positioned to be counted, a method of optically detecting the card edges and counting the number of cards in a stack of cards on edge, comprising the steps of:
illuminating the edges of a plurality of cards located at the card counting location with an artificial light source;
a photosensor mounted in a fixed position within the housing for generating electrical signals representative of light received by the photosensor;
directing light of the light source dispersed from the contiguous edges of the stack of cards towards a photosensor;
focusing the reflected light directed toward the photosensor toward to simultaneously create a complete view of the entire stack of cards on the photosensor
interfacing electrical signals representative of the directed light received by the photosensor to a computer; and
interpreting with the computer the interfaced electronic signals to determine a count for display.
